(19) United States
(12) Patent Application Publication
(10) Pub. No.: US 2002/0149672 A1
(43) Pub. Date: Oct. 17, 2002

(54) Modular video conferencing system

(76) Inventors: Craig S.K. Clapp, Boxford, MA (US); Gary Arthur Brown, Saugus, MA (US)

Correspondence Address: ROPES & GRAY, ONE INTERNATIONAL PLACE, BOSTON, MA, 02110-2624, US

(21) Appl. No.: 09/834,325

(22) Filed: Apr. 13, 2001

(51) Int. Cl. H04N 7/14

(52) U.S. Cl. 348/14.09; 348/14.08; 348/14.01

(57) ABSTRACT

There is provided herein a modular video conferencing system. The system may include, for example, a main unit, a camera unit, and a docking station, each adapted to be removably attached to at least one of the others. The main unit may house a processor, memory, mass storage, and other hardware and software consistent with a video conferencing system. The main unit may include a camera adapter that electrically and mechanically connects the main unit to the camera unit. The camera unit may be directed to change pan, tilt, focus, zoom, and so forth through control signals transmitted from the main unit to the camera unit through the camera adapter. The camera unit may include a plurality of microphones that provide audio signals to the main unit through the camera adapter, and these audio signals may be used by the main unit to determine a location of an audio source relative to the camera unit so that the camera unit may be directed at the audio source. The main unit may include a docking station adapter that electrically and mechanically connects the main unit to the docking station. The docking station may include one or more network ports that connect the modular video conferencing system to a telecommunications or data network. The docking station may include suitable circuitry for coupling the main unit to the one or more network ports in a communicating relationship.

### BACKGROUND OF THE INVENTION

International standards have been devised to provide a uniform platform for video conferencing. These standards may define network protocols, coding and decoding techniques, and other specifications to ensure compatibility among components in a video conferencing system. Typically, the terminals in such a system reside in dedicated video conferencing devices with ports physically adapted for connection to a network, or in computer devices, such as desktop computers, rack mounted computers, and so forth, along with hardware and software conforming the general purpose computing device to the specifications of the video conferencing system.

As a significant disadvantage, dedicated devices are generally difficult to adapt to different environments, such as different network connections, and do not provide a convenient upgrade path for subcomponents such as cameras, speakers, and microphones. Terminals that are based upon general purpose computers also present disadvantages, such as poor portability, and hardware upgrades that may be difficult for an end user, such as disassembly and removal of casing and swapping of computer cards that are susceptible to electrostatic discharge.

There remains a need for a modular dedicated video conferencing system with detachable modules organized along functional lines.

### SUMMARY OF THE INVENTION

There is provided herein a modular video conferencing system. The system may include, for example, a main unit, a camera unit, and a docking station, each adapted to be removably attached to at least one of the others. The main unit may house a processor, memory, mass storage, and other hardware and software consistent with a video conferencing system. The main unit may include a camera adapter that electrically and mechanically connects the main unit to the camera unit. The camera unit may be directed to change pan, tilt, focus, zoom, and so forth through control signals transmitted from the main unit to the camera unit through the camera adapter. The camera unit may include a plurality of microphones that provide audio signals to the main unit through the camera adapter, and these audio signals may be used by the main unit to determine a location of an audio source relative to the camera unit so that the camera unit may be directed at the audio source. The main unit may include a docking station adapter that electrically and mechanically connects the main unit to the docking station. The docking station may include one or more network ports that connect the modular video conferencing system to a telecommunications or data network. The docking station may include suitable circuitry for coupling the main unit to the one or more network ports in a communicating relationship.

In one embodiment, a video conferencing system as described herein comprises a main unit, the main unit including a device interface, a camera adapter, a docking station adapter, a processor, and a memory. The device interface may include one or more ports, each of the one or more ports adapted to provide an output to a device or receive an input from a device. The processor and the memory may be configured to perform video conferencing functions. The camera adapter may be configured to removably receive a camera unit that provides audio and video signals to the main unit through the camera adapter, the processor of the main unit programmed to process the audio signals and, in response to the audio signals, to generate control signals to control at least one of the direction or zoom of the camera unit. The docking station adapter may be configured to removably couple to a docking station that connects the main unit in a communicating relationship with a video conferencing network.

The device interface may provide a connection to one or more video conferencing peripherals. The system may further include a camera unit removably electrically and mechanically connected to the main unit and connected in a communicating relationship with the main unit through the camera adapter, the camera unit including a plurality of microphones that provide the audio signals to the main unit and a camera that provides the video signals to the main unit, the camera including at least one of a controllable direction or a controllable zoom responsive to the control signals generated by the main unit. The system may further include a docking station, the docking station removably electrically and mechanically connected to the main unit and connected in a communicating relationship with the main unit through the docking station adapter, the docking station including a network port for connecting the docking station in a communicating relationship with a video conferencing network and circuitry for converting video conferencing network data between a first format compatible with the video conferencing network and a second format compatible with the docking station adapter.

At least one of the docking station or the camera unit may receive power from the main unit. The main unit may further include a mass storage device that stores a program implementing one or more video conferencing protocols. The one or more video conferencing peripherals may include at least one of a speaker, a microphone, a video monitor, a camera, or a projector. The video conferencing functions may include coding and decoding audio data and coding and decoding video data. The video conferencing functions may include providing a user interface to a user of the system. The plurality of microphones may have predetermined locations relative to the camera, and the processor of the main unit may calculate a location of an audio source relative to the camera using the predetermined locations of the plurality of microphones and an audio signal received from each of the plurality of microphones, and the processor may responsively generate control signals to the camera to steer the camera to the location of the audio source.

The controllable direction may include a controllable pan and a controllable tilt. The docking station may include at least one of a Peripheral Component Interface card, a Multi-Vendor Integrated Protocol card, or a Peripheral Component Interface/Multi-Vendor Integrated Protocol card. The network port may include at least one of a data network port or a telecommunications network port. The network port may include at least one of a Digital Subscriber Line port, an Integrated Services Digital Network port, a T1 line port, an E1 line port, a V.35 port, a Wireless Local Area Network port, or a Fiber Distributed Data Interface port. The system may include one or more media processors that support processing of audio or video data in a video conference.

In an embodiment, a docking station described herein consists essentially of a first adapter configured to mechanically and electrically connect to a video conferencing unit; a second adapter configured to be connected in a communicating relationship with a network; circuitry within the docking station and receiving power from the first adapter to receive first signals from the first adapter, convert the first signals into a form suitable for the network, and output the converted signals on the second adapter, and circuitry housed within the docking station and receiving power from the first adapter to receive second signals from the second adapter, convert the second signals into a form suitable for the video conferencing unit; and a housing, the housing substantially enclosing the first adapter except where the first adapter is exposed to connect to the video conferencing unit, the housing substantially enclosing the second adapter except where the second adapter is exposed to connect to the network, and the housing substantially enclosing the circuitry.

In an embodiment a docking station as described herein includes a first adapter, a second adapter, circuitry, and a housing wherein: the first adapter is configured to mechanically and electrically connect to a video conferencing unit; the second adapter is configured to be connected in a communicating relationship with a network; the circuitry is within the housing and the circuitry receives power from at least one of the first adapter and the second adapter, the circuitry configured to receive first signals from the first adapter, convert the first signals into a form suitable for the network, and output the converted signals on the second adapter, and the circuitry configured to receive second signals from the second adapter, convert the second signals into a form suitable for the video conferencing unit; and the housing substantially enclosing the first adapter except where the first adapter is exposed to connect to the video conferencing unit, the housing substantially enclosing the second adapter except where the second adapter is exposed to connect to the network, and the housing substantially enclosing the circuitry, the housing configured to support the video conferencing unit when connected thereto.

A docking station as described herein may include a video conferencing unit adapter and a network port, the docking station housing a computer card, the computer card being at least one of a Multi-Vendor Integration Protocol card, a Peripheral Component Interface card, or a Multi-Vendor Integration Protocol/Peripheral Component Interface card, a bus connector of the computer card coupled to the video conferencing unit adapter for connecting in a communicating relationship with a bus of a video conferencing unit, and a network interface of the computer card coupled to the network port for connecting in a communicating relationship with a network, the computer card adapted to maintain communication between the video conferencing unit adapter and the network port.

A camera unit as described herein may include: an adapter that is removably electrically and mechanically attachable to a video conferencing system; a camera, the camera responsive to control signals received through the adapter to change at least one of a pan, a tilt, or a zoom of the camera; a plurality of microphones having predetermined locations relative to the camera, the plurality of microphones providing audio signals to the adapter, whereby the audio signals may be received through the adapter from the camera unit, processed externally to the camera unit to determine a location of a source of the audio signals, and suitable control signals provided through the adapter to the camera unit to steer the camera toward the location of the source of the audio signals.

A docking station as described herein may include a first adapter, a second adapter, circuitry, and a housing. The first adapter may be configured to be connected in a communicating relationship with an external medium. The second adapter may be configured to mechanically and electrically connect to a video conferencing unit. The circuitry may be within the housing and may receive power from at least one of the first adapter and the second adapter, the circuitry configured to receive first signals from the first adapter, convert the first signals into a form suitable for the video conferencing unit, and output the converted signals on the second adapter. The housing may substantially enclosing the first adapter except where the first adapter is exposed to connect to the video conferencing unit, the housing may substantially enclosing the second adapter except where the second adapter is exposed to connect to the network, and the housing may substantially enclosing the circuitry, the housing configured to support the video conferencing unit when connected thereto.

In the docking station, the circuitry may be configured to receive second signals from the second adapter and convert the second signals into a form suitable for the external medium. The external medium may be, for example, a mass storage device, a CD ROM, or a DVD player.

A video conferencing system as described herein may include a main unit, the main unit including a device interface, a docking station adapter, a processor, and a memory. The device interface may include one or more ports, each of the one or more ports adapted to provide an output to a device or receive an input from a device. The processor and the memory may be configured to perform video conferencing functions. The docking station adapter may be configured to removably couple to a docking station that connects the main unit in a communicating relationship with a video conferencing network. One of the one or more ports may be connected to a camera.

### BRIEF DESCRIPTION OF DRAWINGS

The foregoing and other objects and advantages of the invention will be appreciated more fully from the following further description thereof, with reference to the accompanying drawings, wherein:

FIG. 1 shows a video conferencing system that may be used with the invention;

FIG. 2 shows a view of a modular video conferencing system;

FIG. 3 shows a block diagram of a main unit of a modular video conferencing system;

FIG. 4 shows a block diagram of a camera unit of a modular video conferencing system;

FIG. 5 shows a block diagram of a docking station of a modular video conferencing system; and

FIG. 6 shows a view of an embodiment of a docking station.

### DETAILED DESCRIPTION OF THE PREFERRED EMBODIMENT(S)

To provide an overall understanding of the invention, certain illustrative embodiments will now be described, including a modular video conferencing system that includes a main unit that provides a processor and additional circuitry to support video conferencing functions, a camera unit that includes a camera and microphone array, and a docking station that includes a computer card for providing an interface to a network. However, it will be understood by those of ordinary skill in the art that the methods and systems described herein may be suitably adapted to other distributions of hardware and functionality in a video conferencing unit. For example, a camera may be built into the main unit, and a two-part system of a docking station and main unit may be used as a video conferencing unit. As another example, the camera unit may autonomously locate audio sources and adjust camera direction accordingly, although in the system described below, source location algorithms are performed in the main unit. All such adaptations and modifications that would be clear to one of ordinary skill in the art are intended to fall within the scope of the invention described herein.

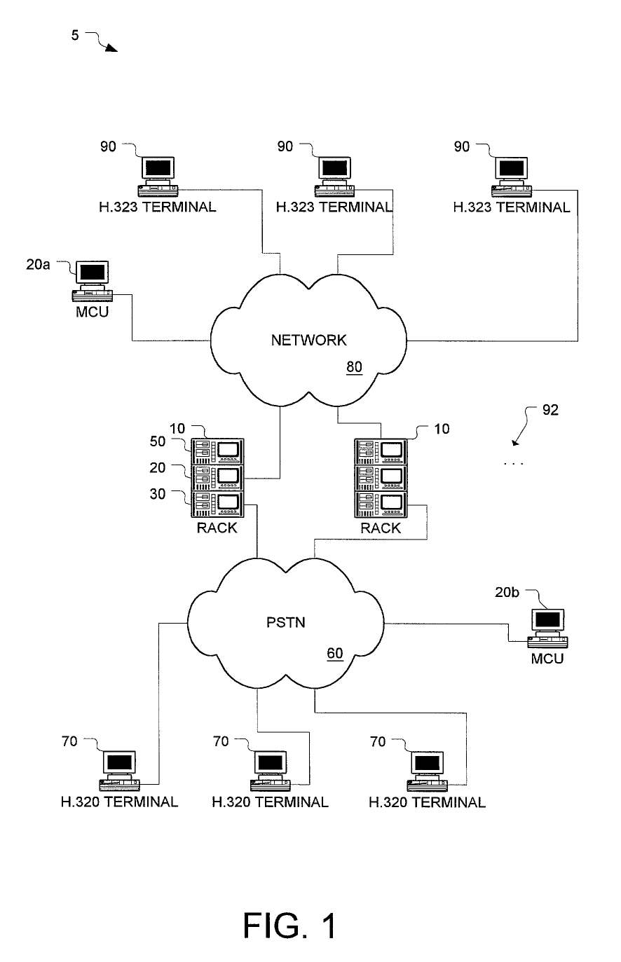

FIG. 1 shows a video conferencing system that may be used with the invention. In a video conferencing network 5, a rack 10 may include a multi-point conference unit (“MCU”) 20, a gateway 30, and hardware/software for other services. The gateway 30 may provide one or more connections to the Public Switched Telephone Network 60, for example, through high speed connections such as Integrated Services Digital Network (“ISDN”) lines, T1 lines, or Digital Subscriber Lines (“DSL”). A plurality of PSTN video conferencing (“VC”) terminals 70 may also be connected in a communicating relationship with the PSTN 60, and may be accessible using known telecommunications dialing and signaling services. The MCU 20 may be connected in a communicating relationship with the Internet 80. A plurality of Internet Protocol (“IP”) VC terminals 90 may also be connected in a communicating relationship with the Internet 80, and may be accessible using known data networking techniques, such as IP addressing.

It will be appreciated that, although the following description refers to an IP network 80 and the PSTN 60, any network for connecting terminals may be usefully employed as a video conferencing network according to the principles of the invention. The IP network 80, for example, may be any packet-switched network, a circuit-switched network (such as an Asynchronous Transfer Mode (“ATM”) network), or any other network for carrying data, and the PSTN 60 may be any circuit-switched network, or any other network for carrying circuit-switched signals or other data. It will additionally be appreciated that the PSTN 60 and/or the IP network 80 may include wireless portions, or may be completely wireless networks. It will also be appreciated that the principles of the invention may be usefully employed in any multimedia system.

It will be appreciated that the components of the rack 10, such as the MCU 20, the gateway 30, and the other services 50, may be realized as separate physical machines, as separate logical machines on a single physical device, or as separate processes on a single logical machine, or some combination of these. Additionally, each component of the rack 10, such as the gateway 30, may comprise a number of separate physical machines grouped as a single logical machine, as for example, where traffic through the gateway 30 exceeds the data handling and processing power of a single machine. A distributed video conferencing network may include a number of racks 10, as indicated by an ellipsis 92.

Each PSTN VC terminal 70 may use an established telecommunications video conferencing standard such as H.320. H.320 is the International Telecommunication Union telecommunications (“ITU-T”) standard for sending voice and audio over the PSTN 60, and provides common formats for compatible audio/video inputs and outputs, and protocols that allow a multimedia terminal to utilize the communications links and synchronize audio and video signals. The T.120 standard may also be used to enable data sharing and collaboration. Each PSTN VC terminal 70 may include inputs such as a microphone, video camera, and keyboard, and may include outputs to display video content such as a monitor and a speaker. As used herein, the term “display” is intended to refer to any rendering of media, including audio, still video, moving video, and so forth, through speakers, headphones, monitors, projectors, or other rendering devices, unless another meaning is indicated. The H.320 and T.120 standards may be implemented entirely in software on a computer, or in dedicated hardware, or in some combination of these.

Each PSTN VC terminal 70 may include coder/decoders (“codecs”) for different media. Video codecs may include codecs for standards such as H.261 FCIF, H.263 QCIF, H.263 FCIF, H.261 QCIF, and H.263 SQCIF. These are well known teleconferencing video standards that define different image size and quality parameters. Audio codecs may include codecs for standards such as G.711, G.722, G.722.1, and G.723.1. These are well known teleconferencing audio standards that define audio data parameters for audio transmission. Any other proprietary or non-proprietary standards currently known, or that may be developed in the future, for audio, video, and data may likewise be used with the invention, and are intended to be encompassed by this description. For example, current H.320 devices typically employ monaural sound, however, the principles of the invention may be readily adapted to a conferencing system employing stereo coding and reproduction, or any other spatial sound representation.

The gateway 30 may communicate with the PSTN 60, and may translate data and other media between a form that is compatible with the PSTN 60 and a form that is compatible with the Internet 80, including any protocol and media translations required to transport media between the networks.

Each IP VC terminal 90 may use an established data networking video conferencing standard such as H.323. H.323 is the ITU-T standard for sending voice and audio over data networks using IP, and provides common formats for compatible audio/video inputs and outputs, and protocols that allow a multimedia terminal to utilize the communications links and synchronize audio and video signals. The T.120 standard may also be used to enable data sharing and collaboration. Each IP VC terminal 90 may include inputs such as a microphone, video camera, and keyboard, and may include outputs to display video conferencing content such as a monitor and a speaker. The H.323 and T.120 standards may be implemented entirely in software on a computer, or in dedicated hardware, or in some combination of these. Each IP VC terminal 90 typically also includes standard audio and video codecs, such as those described for the PSTN VC terminals 70.

The MCU 20 may communicate with the IP VC terminals 90 over the Internet 80, or with the PSTN VC terminals 70 over the PSTN 60. The MCU 20 may include hardware and/or software implementing the H.323 standard (or the H.320 standard, where the MCU 20 is connected to the PSTN 60) and the T.120 standard, and also includes multipoint control for switching and multiplexing video, audio, and data streams in a multimedia conference. The MCU 20 may additionally include hardware and/or software to receive from, and transmit to, PSTN VC terminals 70 connected to the gateway 30. As shown in FIG. 1, an MCU 20 may reside on one of the racks 10, or may be located elsewhere in the network, such as MCU's 20a and 20b. It will be appreciated that an MCU 20 may also reside on one of the PSTN VC terminals 70, or one of the IP VC terminals 90, and may be implemented in hardware, software, or some combination of these.

The rack 10 may provide additional services for use in a video conferencing network. These may include, for example, audio/video coder/decoders (“codecs”) that are not within the H.323 or H.320 standards, such as the G2 encoder and streamer for use with a proprietary streaming system sold by RealNetworks, Inc., and a Windows Media codec for use with proprietary media systems sold by Microsoft Corporation. Other services may include, for example, a directory server, a conference scheduler, a database server, an authentication server, and a billing/metering system.

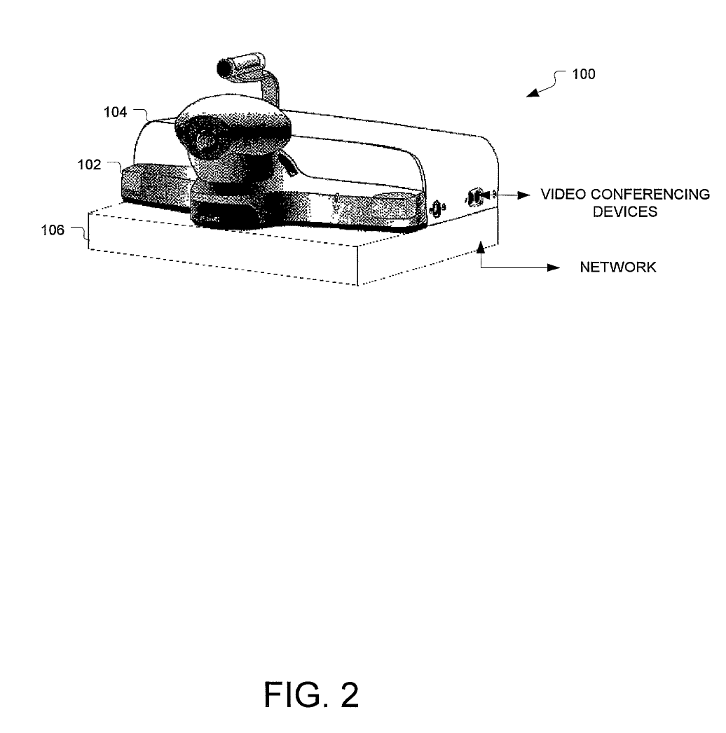

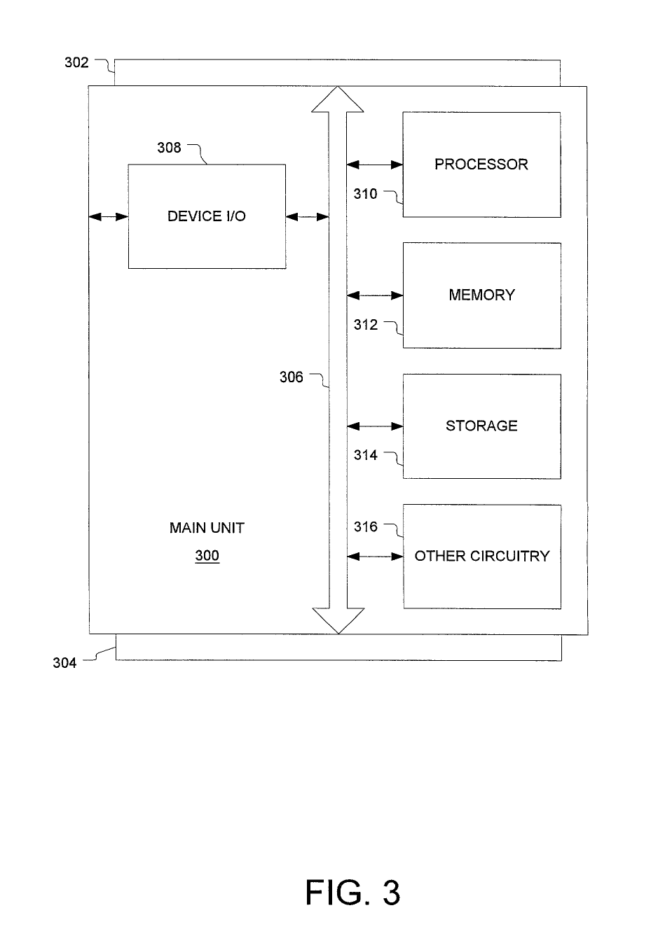

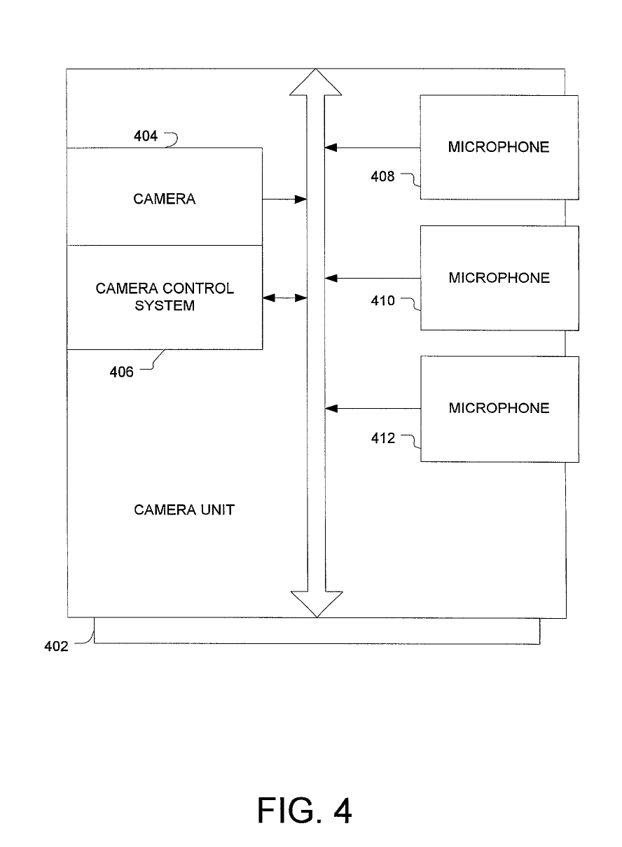

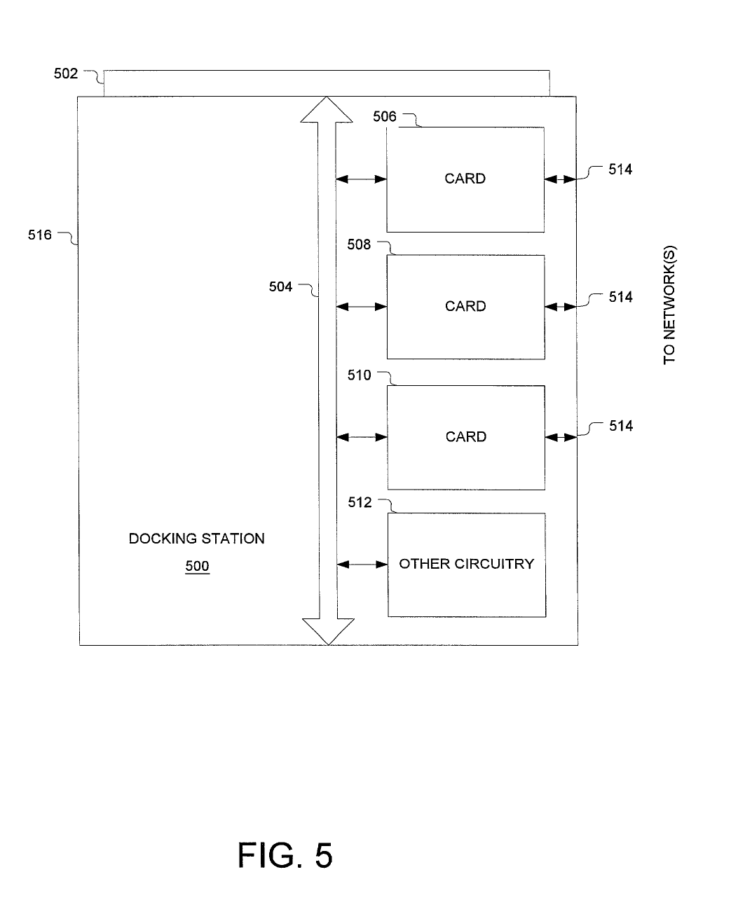

FIG. 2 shows a view of a modular video conferencing system. The system 100 may include a camera unit 102, a main unit 104, and a docking station 106. The camera unit 102 may include, for example, an array of microphones, a video camera, and steering controls to direct and zoom the video camera. The camera unit 102 may operate generally to provide video capture of a participant in a video conference or other video conference content. The camera unit 102 is described in more detail below with reference to FIG. 4. The main unit 104 may include a processor, memory, mass storage, and ports for one or more video conferencing devices. The main unit 104 is described in more detail below with reference to FIG. 3. The docking station 106 may include circuitry, such as on a computer card, for communicating video conferencing content and data between the main unit 104 and a network. The docking station is described in more detail below with reference to FIG. 5.

The camera unit 102 may be removably and replaceably attached to the main unit 104 through an adapter or connector. The adapter may form a mechanical connection between the camera unit 102 and the main unit 104 so that the camera unit 102 is supported in position by the main unit 104. The mechanical connection may include a locking mechanism to prevent separation of the camera unit 102 from the main unit 104, such as during movement of the main unit 104 between one or more docking stations 106. The adapter may form an electrical connection between the camera unit 102 and the main unit 104 using, for example conventional bus connectors, ribbon connectors, or any other mating connectors that may be keyed to, or aligned with, the mechanical connection so that mechanical and electrical connections are formed at one time. The mechanical connection may be configured so that mechanical mating of the camera unit 102 and the main unit 104 aligns electrical connection components before the electrical connection components of the camera unit 102 and the main unit 104 come into contact with each other. The electrical connection may carry, for example, audio data or signals, video data or signals, control data or signals, and power.

The docking station 106 may be removably and replaceably attached to the main unit 104 through an adapter or connector. The adapter may form a mechanical connection between the docking station 106 and the main unit 104 so that the main unit 104 is supported in position by the docking station 106. The mechanical connection may include a locking mechanism to prevent separation of the main unit 104 from the docking station 106, such as due to user contact with the main unit 104 during use. The adapter may form an electrical connection between the docking station 106 and the main unit 104 using, for example conventional bus connectors, ribbon connectors, or any other mating connectors that may be keyed to, or aligned with, the mechanical connection so that mechanical and electrical connections are formed at one time. The mechanical connection may be configured so that mechanical mating of the docking station 106 and the main unit 104 aligns electrical connection components before the electrical connection components of the docking station 106 and the main unit 104 come into contact with each other. The electrical connection may carry, for example, video conferencing network data or signals, such as video conference content, control data, or network data such as address and protocol information. The data may be transmitted, for example, according to the PCI and/or MVIP protocols.

FIG. 3 shows a block diagram of a main unit of a modular video conferencing system. The main unit 300 may include a first adapter 302, a second adapter 304, a bus 306, a device input/output (“I/O”) 308, a processor 310, a memory 312, a storage 314, and other circuitry 316. The main unit 300 may be, for example, the main unit 104 of FIG. 2. It will be appreciated that the bus 306 depicted in FIG. 3 may be a single bus or a number of separate busses and or other connections for interconnecting, as appropriate, the components of the main unit 300.

The processor 310 may be any microprocessor, microcontroller, or any other semiconductor device, or other device or combination of devices suitable for realizing video conferencing functions, such as a video conferencing user interface and implementation of the H.320 and/or H.323 standards. It will be appreciated that some video conferencing functions and other functions described herein may also be implemented in the other circuitry 316 described below. As such, the term “processor”, as used herein, may refer to the processor 310 described above, the other circuitry 316, or some combination of these, and the discrete representation of the processor 310 of FIG. 3 should not be interpreted to suggest or require that all processing functions are performed by the processor 310. The memory 312 may be any volatile or non-volatile, static or dynamic random access memory suitable for use with the processor 310. The storage 314 may include a hard disk drive or any other storage device, mass storage device or other device for storing programs and other data for use by the processor 310 and the other components of the main unit 300. The processor 310, memory 312, and storage 314 may be of sufficient size and power to support functionality associated with video conferencing, and where appropriate, to further control the other circuitry 316 for use in video conferencing functions. The processor 310 may also provide a user interface through a keyboard, mouse, computer monitor, remote control such as an infrared remote control, and/or other interface devices through the device I/O 308.

One suitable combination of hardware is a 566 MHz Celeron microprocessor from Intel Corporation, one-hundred twenty-eight megabytes of dynamic random access memory, and a hard drive with ten gigabytes of storage. The processor 310 may operate on an operating system such as Windows 2000 from Microsoft Corporation, and may employ application programming interfaces, drivers, and other programs to provide a user interface through the interface devices, and to control operation of the main unit 300. Other applications such as word processing programs, spread sheet programs, computer aided design programs, presentation programs (such as Power Point), and other programs may be provided for data sharing conferencing applications and other uses by a user of the main unit 300.

The other circuitry 316 may include any other circuitry that provides support for operation of the main unit 300, or support for media processing, including for example, codec implementation, audio and video processing, and signal processing such as gain control, echo cancellation, and so forth. This may include, for example, coder/decoders for audio and video standards used in video conferencing, as well as graphics accelerators, co-processors, programmable digital signal processors, analog-to-digital converters, digital-to-analog converters, and so forth. The other circuitry 316 may include application specific integrated circuits, programmable gate arrays, programmable array logic, or any other chips, chipsets, or other discrete or packaged devices suitable for use with the main unit 300. The other circuitry 316 may include additional processors such as, for example, one or more TriMedia processors available from Philips Semiconductors, or any other processor suitable for providing media processing support.

The device I/O 308 may include input and output circuitry for video conferencing peripherals, such as display equipment, user interface devices, mass storage devices (hard disk drives, CD-ROMs, recordable CD-ROMs, etc.), microphones, cameras, or other devices that might be attached to the main unit 300. For example, the device I/O 308 may include circuitry, transducers, and connectors for ports connecting to Universal Serial Bus devices, infrared (“IR”) user interface devices, a Video Cassette Recorder (“VCR”) audio input and output, VCR video input and output, a monitor output, an S-Video input and output, a microphone input, a steerable beam microphone input, a video camera input, a document camera input, audio input and VGA input for use with, for example, a portable computer, a VGA output, a keyboard input, a mouse input, an ISDN connection, a Local Area Network connection, Public Switch Telephony Network (“PSTN”) connections, speaker or headphone outputs, headset audio input, serial ports, and parallel ports. Devices such as a mouse, a keyboard, a printer, or any other conventional computer device, peripheral or user interface device may also be connected to the device I/O 308. Support for one or more of the device I/O's may be provided by the processor, using software implemented drivers and interfaces, or through an interface provided by the other circuitry 316.

The first adapter 302 may include any mechanical and electrical connection features suitable for a camera unit, such as the camera unit 102 of FIG. 2. In one embodiment, the main unit 300 may not include an adapter for a camera unit. In this embodiment, a camera signal may be provided, for example, through one of the ports of the device I/O 308. The second adapter 304 may include any mechanical and electrical connection features suitable for connecting the main unit 300 to a docking station, such as the docking station 106 of FIG. 2.

FIG. 4 shows a block diagram of a camera unit of a modular video conferencing system. The camera unit 400 may include an adapter 402, a bus 403 interconnecting the adapter 402 with other components of the camera unit 400, a camera 404, a camera control system 406, and a plurality of microphones 408-412. The camera unit 400 may be the camera unit 102 of FIG. 2, and the adapter 402 may be configured to electrically and mechanically connect to the main unit 104 of FIG. 2. The adapter 402 may include, for example, a 20-pin connector such as a MOLEX 52326-0201, with a mating adapter on the main unit 300, such as a MOLEX 52411-0201. The bus 403 may include any standard bus, a proprietary bus, or any point-to-point wiring for electrically interconnecting the components of the camera unit 400.

The camera 404 may be any camera for electronically transmitting still or moving images to the main unit 102 through the bus 403 and the adapter 402. The camera may be, for example, a camera generating video signals compliant with National Television Standards Committee (“NTSC”) standards used in the United States for television signals, or the Phase Alternating Line (“PAL”) standard that is predominant in Europe.

The camera control system 406 may include one or more motors, servos, or other electro-mechanical actuators to control operation of the camera 404. This may include, for example, control of camera zoom, camera focus, and directional control such as pan or tilt of the camera 404. The camera control system 406 may operate in response to control signals received through the adapter 402 and the bus 403 from the main unit 104 of FIG. 2, so that, when attached to the main unit 102, the camera unit 400 may be controlled by user input received by the main unit 102, or by control algorithms executing on the processor 310 of the main unit 300 of FIG. 3. Suitable cameras and control components may be found, for example, in a Model 80 (Cosmo) MPTZ camera sold by PictureTel Corporation.

In one embodiment, the camera control system 406 may include an infrared transceiver (not shown). The infrared transceiver may receive camera control signals from an infrared remote control, so that the control signals may be processed directly at the camera unit 400 or in the main unit 300. The control signals may invoke control algorithms, or may include direct manual control commands that override other control signals. It will be appreciated that such an infrared system may also, or instead, reside in the main unit 300 of FIG. 3.

The microphones 408-412 may be disposed upon the exterior of the camera unit 400 in predetermined locations. It will be appreciated that, although three microphones are shown, fewer microphones or more microphones may be used. The control algorithms executing on the main unit 300 may respond to manual user input, or may process audio signals received from the microphones 408-412, along with information about the location of each microphone relative to the camera 404, to locate an audio source and direct the camera 404, through control signals to the camera control system 406, toward the audio source. Video data may also be used alone, or in combination with audio data, to locate an object or person of interest in a video conferencing environment. One suitable system and method for locating audio sources with an array of microphones and video data is described, for example, in U.S. Pat. App. Ser. No. 09/079,840, entitled “Locating an Audio Source,” the teachings of which are incorporated herein by reference.

It will be appreciated that a number of techniques may be used to provide information concerning the location of each of the plurality of microphones 408-412. For example, the camera control system 406 may store location data for the microphones 408-412 in a non-volatile memory, and provide the location data to the bus 403 and the adapter 402 upon power up, according to a predetermined protocol. Similarly, the camera unit 400 may provide a type identifier from which the main unit 300 can determine location data. The main unit 300 may allow user input of suitable location data through a user interface, or may allow user input of a camera model, type, or other data from which the main unit 300 may determine location data. The above mentioned techniques may be used to provide calibration data for the plurality of microphones 408-412, such as an amplitude and phase error for each microphone. The calibration data may, for example, be obtained for a camera unit 406 and stored by the camera control system 406 of the camera unit 400, where it may be accessed by a main unit connected to the camera unit 400, or by other components of the camera unit 400.

In one embodiment, the camera unit 400 may operate autonomously to locate an audio source. That is, audio signals from the microphones 408-412 may be provided to the camera control system 406, which may process the audio signals independent of the main unit 300 to locate an audio source and steer the camera 404 accordingly. One or more of the microphones 408-412 may supply audio data for the video conference, or video conference audio may be provided from another microphone connected to the main unit 300 of FIG. 3.

FIG. 5 shows a block diagram of a docking station of a modular video conferencing system. The docking station 500 may include an adapter 502, a bus 504 such as a PCI bus, one or more cards 506-510 suitable for connection to the bus 504, other circuitry 512, and a port 514. The adapter 502 may be configured for connection to the main unit 300 of FIG. 3, and a mother board of the main unit 300 may include, for example, a connector for communicating PCI and/or MVIP signals. In this arrangement, the bus 504 may be an extension of a PCI bus within the main unit 300, and the cards 506-510 may be, for example PCI and/or MVIP cards available from card manufacturers and vendors. The bus 504 and associated cards 506-510 may be usefully employed to provide an interface to a video conferencing network through, for example, a Quad Basic Rate Interface (“BRI”) ISDN PCI card, a Dual V.35/RS-449 PCI card, an Asynchronous Transport Mode (“ATM”) PCI card, or a T1/E1 interface PCI card. Other network interfaces, such as LAN interfaces, Digital Subscriber Line interfaces, and PSTN interfaces, may be used with the invention.

In addition to providing a network interface to the main unit 300 through the bus 504 and the adapter 502, other circuitry 512 may be provided, including circuitry for any other functionality that may be provided on a card and used in a video conferencing system, including high-density conferencing boards, switch matrixes, bridges, and so forth. The other circuitry 512 may also include circuitry and devices such as mass storage devices, media accelerators, codecs, and so forth, or circuitry and connectors for connecting to external devices. Although not shown in FIG. 5, it will be appreciated that additional ports 514 may be provided for the other circuitry 512, such as for connection to an external mass storage device.

It should be appreciated that, while the PCI standard provides a commonplace and readily available telecommunications system solution for the docking station bus 504 and cards 506-512, other standards-based or proprietary bus structures may be usefully employed with the system described herein. One such example is the Multi-Vendor Integrated Protocol (“MVIP”) standard, devised for telecommunications applications. The docking station bus 504 may connect to the main unit 300 and interconnect the cards 506-512 using the MVIP standard. Other arrangements may be used, such as a docking station bus 504 that includes an MVIP bus and a PCI bus, as well as non-standard interconnections. One or more of these standards-based busses, or other custom or proprietary busses, may be connected to the main unit 300 through the adapter 502. Another example of a bus standard suitable for use in the docking station 500 is the emerging InfiniBand standard for high-speed switching fabrics.

In one embodiment, the adapter 502 may present a synchronous interface and/or an asynchronous interface to the main unit 300, including, for example, a complete extension of a PCI bus, a signal set for the ATX Riser Card Specification, and a sub-set of MVIP interface signals. The adapter 502 may include a 220-pin connector using, for example, a JAE PD1B220V9E self-aligning connector, with a mating JAE PD1R220V9E on the main unit 300.

The docking station 500 may include a housing 516, shown generally as a rectangular box enclosing the docking station bus 504 and other components. The housing may substantially enclose the bus 504, the cards 506-510, and other circuitry 512. The housing may also enclose the adapter 502, except where the adapter 502 is exposed to form a connection to the main unit 300. The ports 514 may be sockets, connectors, or any other components used to form a connection to a network, such as a video conferencing network, according to one of the standards noted above. The ports 514 may also include an open portion in the housing for connection to one of the cards 506-510. The ports 514 may also include, for example, any other connector or interface, such as to a mass storage device. It will be appreciated that, while the housing 516 substantially encloses the above components, the housing 516 need not necessarily entirely enclose all of the components, and openings may be provided, for example, for ventilation, or for indicators such as light-emitting diodes and the like.

FIG. 6 shows a view of an embodiment of a docking station. The docking station 600 may include a main unit mating 601, a transition board 602, a PCI bus connector 604, an MVIP-compatible ribbon cable 605, a PCI/MVIP card 606 connected to the ribbon cable 605 through an MVIP header 607, a network connection 614 for connecting to a network cable 615, and a docking enclosure 616. The main unit mating 601, PCI/MVIP card 606, docking enclosure 616, and network connection 614 may be, for example, the adapter 502, one of the cards 506, the housing 516, and the port 514, respectively, described above with reference to FIG. 5. The network connection 614 may be exposed through an opening in the docking enclosure 616 so that the network cable 615 may be removably connected to the docking station 600, or the docking enclosure may enclose the network connection 614 and a plug of the network cable 615 so that the network cable 615 extends through the docking enclosure 616. The transition board 602 may distribute leads of the main unit mating 601 to one or more connectors of the PCI/MVIP card 606. For example, some leads may be connected to a PCI bus connector 604 that mechanically and electrically mates with the PCI/MVIP card 606. Some leads may be connected to an MVIP connector so that the MVIP-compatible ribbon cable 605 may be connected between the transition board 602 and the MVIP header 607.

It will be appreciated that, although a network connection 614 is shown and described above, the docking station 600 may instead, or in addition, provide a connection to an external medium other than a video conferencing network for input and output of audio data, visual data, or other data relating to a video conference. For example, the docking station 600 may include a port for connecting to a mass storage device, a disk drive, a CDROM, a DVD player, or some other device. In such a system, the PCI/MVIP card 606 may be replaced with input/output circuitry for requesting data from, or storing data on, the external medium. The card may also include circuitry for coding and decoding audio-visual data.

While the invention has been disclosed in connection with the preferred embodiments shown and described in detail, various modifications and improvements thereon will become readily apparent to those skilled in the art. Accordingly, the spirit and scope of the present invention is to be limited only by the following claims.

What is claimed is:

1. A video conferencing system comprising a main unit, the main unit including a device interface, a camera adapter, a docking station adapter, a processor, and a memory,
the device interface including one or more ports, each of the one or more ports adapted to provide an output to a device or receive an input from a device;
the processor and the memory configured to perform video conferencing functions;
the camera adapter configured to removably receive a camera unit that provides audio and video signals to the main unit through the camera adapter, the processor of the main unit programmed to process the audio signals and, in response to the audio signals, to generate control signals to control at least one of the direction or zoom of the camera unit; and
the docking station adapter configured to removably couple to a docking station that connects the main unit in a communicating relationship with a video conferencing network.

2. The system of claim 1 wherein the device interface provides a connection to one or more video conferencing peripherals.

3. The system of claim 1 further comprising a camera unit removably electrically and mechanically connected to the main unit and connected in a communicating relationship with the main unit through the camera adapter, the camera unit including a plurality of microphones that provide the audio signals to the main unit and a camera that provides the video signals to the main unit, the camera including at least one of a controllable direction or a controllable zoom responsive to the control signals generated by the main unit.

4. The system of claim 1 further comprising a docking station, the docking station removably electrically and mechanically connected to the main unit and connected in a communicating relationship with the main unit through the docking station adapter, the docking station including a network port for connecting the docking station in a communicating relationship with a video conferencing network and circuitry for converting video conferencing network data between a first format compatible with the video conferencing network and a second format compatible with the docking station adapter.

5. The system of claim 1 wherein at least one of the docking station or the camera unit receive power from the main unit.

6. The system of claim 1 wherein the main unit further comprises a mass storage device that stores a program implementing one or more video conferencing protocols.

7. The system of claim 2 wherein the one or more video conferencing peripherals include at least one of a speaker, a microphone, a video monitor, a camera, or a projector.

8. The system of claim 1 wherein the video conferencing functions include coding and decoding audio data and coding and decoding video data.

9. The system of claim 1 wherein the video conferencing functions include providing a user interface to a user of the system.

10. The system of claim 3 wherein the plurality of microphones have predetermined locations relative to the camera, the processor of the main unit calculating a location of an audio source relative to the camera using the predetermined locations of the plurality of microphones and an audio signal received from each of the plurality of microphones, and the processor responsively generating control signals to the camera to steer the camera to the location of the audio source.

11. The system of claim 3 wherein the controllable direction includes a controllable pan and a controllable tilt.

12. The system of claim 4 wherein the docking station includes at least one of a Peripheral Component Interface card, a Multi-Vendor Integrated Protocol card, or a Peripheral Component Interface/Multi-Vendor Integrated Protocol card.

13. The system of claim 4 wherein the network port includes at least one of a data network port or a telecommunications network port.

14. The system of claim 4 wherein the network port includes at least one of a Digital Subscriber Line port, an Integrated Services Digital Network port, a T1 line port, an E1 line port, a V.35 port, a Wireless Local Area Network port, or a Fiber Distributed Data Interface port.

15. The system of claim 1 further comprising one or more media processors that support processing of audio or video data in a video conference.

16. A docking station consisting essentially of:
a first adapter configured to mechanically and electrically connect to a video conferencing unit;
a second adapter configured to be connected in a communicating relationship with a network;
circuitry within the docking station and receiving power from the first adapter to receive first signals from the first adapter, convert the first signals into a form suitable for the network, and output the converted signals on the second adapter, and circuitry housed within the docking station and receiving power from the first adapter to receive second signals from the second adapter, convert the second signals into a form suitable for the video conferencing unit; and
a housing, the housing substantially enclosing the first adapter except where the first adapter is exposed to connect to the video conferencing unit, the housing substantially enclosing the second adapter except where the second adapter is exposed to connect to the network, and the housing substantially enclosing the circuitry.

17. A docking station comprising a first adapter, a second adapter, circuitry, and a housing wherein:
the first adapter is configured to mechanically and electrically connect to a video conferencing unit;
the second adapter is configured to be connected in a communicating relationship with a network;
the circuitry is within the housing and the circuitry receives power from at least one of the first adapter and the second adapter, the circuitry configured to receive first signals from the first adapter, convert the first signals into a form suitable for the network, and output the converted signals on the second adapter, and the circuitry configured to receive second signals from the second adapter, convert the second signals into a form suitable for the video conferencing unit; and
the housing substantially enclosing the first adapter except where the first adapter is exposed to connect to the video conferencing unit, the housing substantially enclosing the second adapter except where the second adapter is exposed to connect to the network, and the housing substantially enclosing the circuitry, the housing configured to support the video conferencing unit when connected thereto.

18. A docking station including a video conferencing unit adapter and a network port, the docking station housing a computer card, the computer card being at least one of a Multi-Vendor Integration Protocol card, a Peripheral Component Interface card, or a Multi-Vendor Integration Protocol/Peripheral Component Interface card, a bus connector of the computer card coupled to the video conferencing unit adapter for connecting in a communicating relationship with a bus of a video conferencing unit, and a network interface of the computer card coupled to the network port for connecting in a communicating relationship with a network, the computer card adapted to maintain communication between the video conferencing unit adapter and the network port.

19. A camera unit comprising:
an adapter that is removably electrically and mechanically attachable to a video conferencing system;
a camera, the camera responsive to control signals received through the adapter to change at least one of a pan, a tilt, or a zoom of the camera;
a plurality of microphones having predetermined locations relative to the camera, the plurality of microphones providing audio signals to the adapter, whereby the audio signals may be received through the adapter from the camera unit, processed externally to the camera unit to determine a location of a source of the audio signals, and suitable control signals provided through the adapter to the camera unit to steer the camera toward the location of the source of the audio signals.

20. A docking station comprising:
first adapter means for mechanically and electrically connecting to a video conferencing unit;
second adapter means for connecting in a communicating relationship with a network;
circuitry means for connecting the first adapter means and the second adapter means in a communicating relationship; and
housing means for substantially enclosing the first adapter means, the second adapter means, and the circuitry means, except where the first adapter means is exposed to connect to the video conferencing unit, and where the second adapter means is exposed to connect to the network.

21. A docking station comprising a first adapter, a second adapter, circuitry, and a housing wherein:
the first adapter is configured to be connected in a communicating relationship with an external medium;
the second adapter is configured to mechanically and electrically connect to a video conferencing unit;
the circuitry is within the housing and the circuitry receives power from at least one of the first adapter and the second adapter, the circuitry configured to receive first signals from the first adapter, convert the first signals into a form suitable for the video conferencing unit, and output the converted signals on the second adapter;
the housing substantially enclosing the first adapter except where the first adapter is exposed to connect to the video conferencing unit, the housing substantially enclosing the second adapter except where the second adapter is exposed to connect to the network, and the housing substantially enclosing the circuitry, the housing configured to support the video conferencing unit when connected thereto.

22. The docking station of claim 21, the circuitry configured to receive second signals from the second adapter and convert the second signals into a form suitable for the external medium.

23. The docking station of claim 21 wherein the external medium comprises at least one of a mass storage device, a CD ROM, or a DVD player.

24. A video conferencing system comprising a main unit, the main unit including a device interface, a docking station adapter, a processor, and a memory,
the device interface including one or more ports, each of the one or more ports adapted to provide an output to a device or receive an input from a device;
the processor and the memory configured to perform video conferencing functions; and
the docking station adapter configured to removably couple to a docking station that connects the main unit in a communicating relationship with a video conferencing network.

25. The system of claim 1 wherein one of the one or more ports is connected to a camera.
